(19) United States
(12) Patent Application Publication
(10) Pub. No.: US 2007/0039807 A1
(43) Pub. Date: Feb. 22, 2007

(54) Panel unit, and switch-mounting assembly having the same

(76) Inventor: Jun-Hao Yang, Tainan City (TW)

Correspondence Address: DAVIDSON BERQUIST JACKSON & GOWDEY LLP, 4300 WILSON BLVD., 7TH FLOOR, ARLINGTON, VA, 22203, US

(21) Appl. No.: 11/492,109

(22) Filed: Jul. 25, 2006

(30) Foreign Application Priority Data
Aug. 17, 2005 (TW) 094214072

(51) Int. Cl. H01H 13/00

(52) U.S. Cl. 200/296

(57) ABSTRACT

A switch-mounting assembly includes a switch-mounting frame installed with a switch unit and formed with a first through hole. A panel unit includes a cover for covering the switch-mounting frame and formed with a switch-mounting hole for extension of the switch unit. A screw fastener extends through a second through hole in the cover and the first through hole and is screwed into a coupling member so as to anchor the cover and the switch-mounting frame to the coupling member. The panel unit further includes a decorative piece having a magnetic portion attracting magnetically and contacting a magnetically-attractable screw head portion of the screw fastener, and a decorative portion connected to the magnetic portion, disposed on the outer surface of the cover, and covering the screw head portion of the screw fastener.

### CROSS-REFERENCE TO RELATED APPLICATION

This application claims priority of Taiwanese Application No. 094214072, filed on Aug. 17, 2005.

### BACKGROUND OF THE INVENTION

1. Field of the Invention

The invention relates to a panel unit, more particularly to a switch-mounting assembly having a panel unit that has an attractive appearance and that can be easily assembled and disassembled.

2. Description of the Related Art

FIGS. 1 and 2 illustrate a conventional switch device 1 that includes a coupling member 11 embedded into a wall, a switch-mounting frame 13 installed with a plurality of switch units 14 and anchored to the coupling member 11 by means of a plurality of screw fasteners 12 that extend respectively through a plurality of through holes 133 in the switch-mounting frame 13 and that are screwed into the coupling member 11, and a panel 15 for covering the switch-mounting frame 13. The panel 15 is formed with a plurality of through holes 153 for permitting extension of the switch units 14 therethrough, and has a plurality of engaging hooks 152 extending from an inner surface of the panel 15 toward the coupling member 11 and engaging respectively a plurality of engaging flanges 135 of the switch-mounting frame 13.

In such a configuration, during assembly, the switch-mounting frame 13 is first anchored to the coupling member 11 by means of the screw fasteners 12, and the panel 15 is then assembled to the switch-mounting frame 13 by engagement between the engaging hooks 152 of the panel 15 and the engaging flanges 135 of the switch-mounting frame 13. However, when the conventional switch device 1 is to be disassembled in order to replace or repair the switch units 14, after the panel 15 is removed from the switch-mounting frame 13 by using a tool for disengaging the engaging hooks 152 of the panel 15 from the engaging flanges 135 of the switch-mounting frame 13, the screw fasteners 12 are removed from the coupling member 11 so as to allow removal of the switch-mounting frame 13 from the coupling member 11, thereby resulting in inconvenience during disassembly. Furthermore, frequent disengagement between the engaging hooks 152 of the panel 15 and the engaging flanges 135 of the switch-mounting frame 13 easily results in damage to the engaging hooks 152 of the panel 15.

### SUMMARY OF THE INVENTION

Therefore, the object of the present invention is to provide a panel unit, and a switch-mounting assembly having the same that can be easily assembled and disassembled and that have an attractive appearance.

According to one aspect of the present invention, there is provided a switch-mounting assembly adapted to be mounted with a switch unit and adapted to be connected detachably to a coupling member. The switch-mounting assembly comprises:

a switch-mounting frame having a first side adapted to be installed with the switch unit, and a second side opposite to the first side and adapted to face the coupling member, the switch-mounting frame being formed with a first through hole that extends from the first side to the second side; and

a panel unit including
a cover covering the first side of the switch-mounting frame and having an inner surface that faces the switch-mounting frame, and an outer surface opposite to the inner surface, the cover being formed with a switch-mounting hole extending from the inner surface to the outer surface and adapted for permitting extension of the switch unit on the switch-mounting frame therethrough, and a second through hole extending from the inner surface to the outer surface and aligned with the first through hole in the switch-mounting frame,
a screw fastener having a magnetically-attractable screw head portion, and a screw shank portion connected to the screw head portion and extending through the second through hole in the cover and the first through hole in the switch-mounting frame and adapted to be screwed into the coupling member such that an assembly of the switch-mounting frame and the cover is adapted to be anchored to the coupling member, and
a decorative piece having a magnetic portion attracting magnetically and contacting the screw head portion of the screw fastener, and a decorative portion connected to the magnetic portion, disposed on the outer surface of the cover, and having an area larger than that of the screw head portion of the screw fastener so as to cover the screw head portion of the screw fastener.

According to another aspect of the present invention, there is provided a panel unit adapted for use with a switch device connected detachably to a coupling member. The switch device includes a switch-mounting frame that has a first side, and a second side opposite to the first side and facing the coupling member and that is formed with a first through hole that extends from the first side to the second side, a switch unit mounted on the first side of the switch-mounting frame, and a screw fastener having a magnetically-attractable screw head portion, and a screw shank portion connected to the screw head portion and extending through the first through hole in the switch-mounting frame and screwed into the coupling member. The panel unit comprises:

a cover adapted to cover the first side of the switch-mounting frame and having an inner surface that is adapted to face the switch-mounting frame, and an outer surface opposite to the inner surface, the cover being formed with a switch-mounting hole extending from the inner surface to the outer surface and adapted for permitting extension of the switch unit on the switch-mounting frame therethrough, and a second through hole extending from the inner surface to the outer surface and adapted to be aligned with the first through hole in the switch-mounting frame and adapted for permitting extension of the screw shank portion of the screw fastener; and

a decorative piece having a magnetic portion adapted to attract magnetically and contact the screw head portion of the screw fastener, and a decorative portion connected to the magnetic portion, disposed on the outer surface of the cover, and having an area larger than that of the screw head portion of the screw fastener so as to cover the screw head portion of the screw fastener.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional switch device;

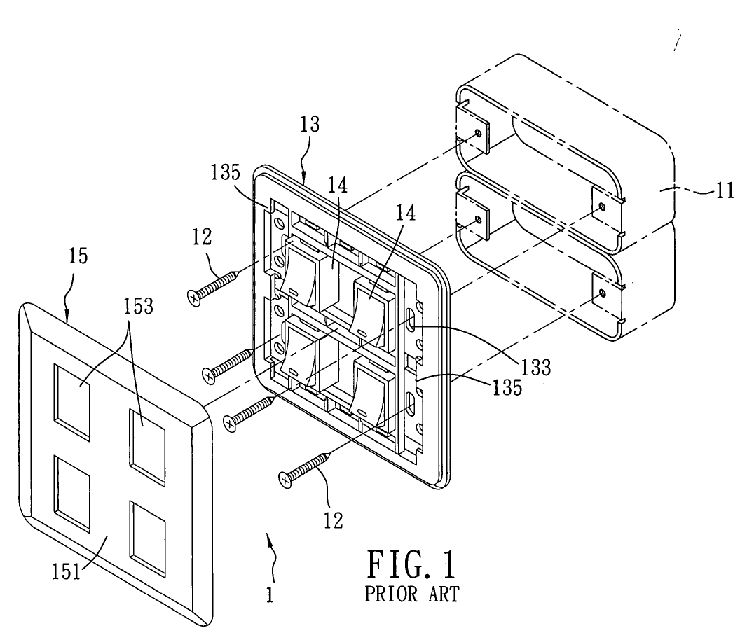

FIG. 2 is a fragmentary exploded perspective view showing a panel and a switch-mounting frame of the conventional switch device;

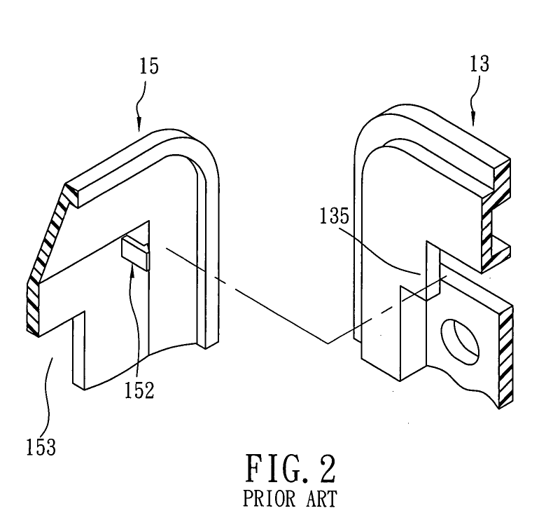

FIG. 3 is an exploded perspective view showing the preferred embodiment of a switch-mounting assembly according to the present invention;

FIG. 4 is an exploded, fragmentary perspective view showing the preferred embodiment;

FIG. 5 is a schematic front view showing the preferred embodiment; and

FIG. 6 is a fragmentary, schematic sectional view of the preferred embodiment taken along line VI-VI in FIG. 5.

### DETAILED DESCRIPTION OF THE PREFERRED EMBODIMENT

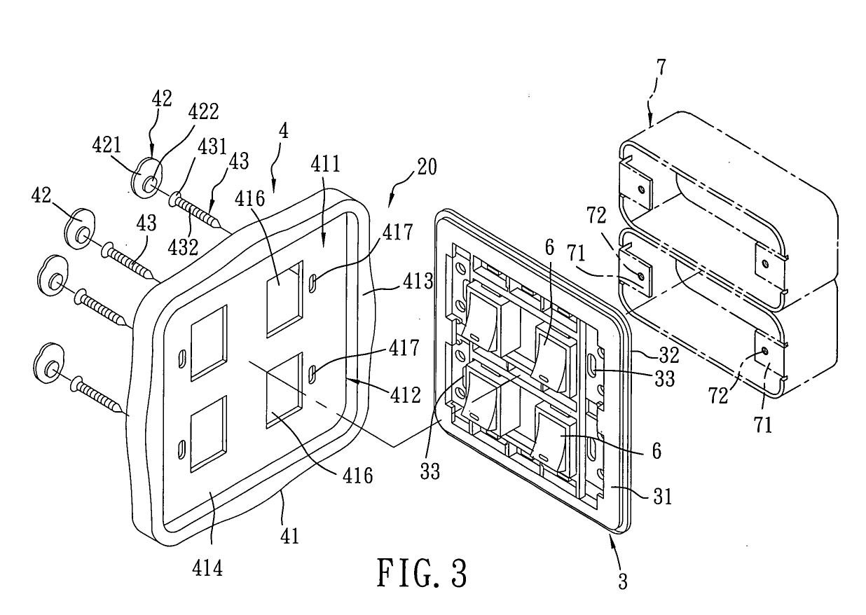

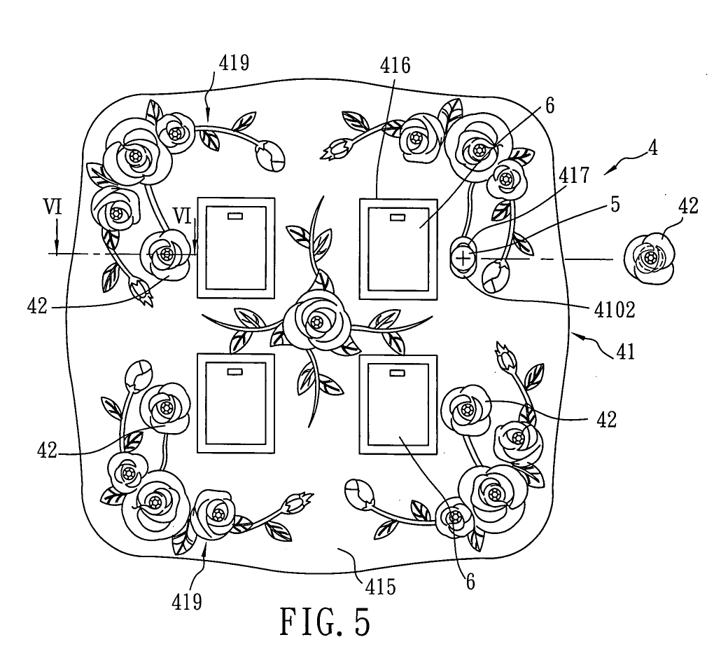

Referring to FIGS. 3 to 5, the preferred embodiment of a switch-mounting assembly 2 according to the present invention is shown to be adapted to be mounted with a plurality of switch units 6, and is adapted to be connected detachably to a coupling member 7. The coupling member 7 has a plurality of coupling plates 71, each of which is formed with a threaded hole 72. The switch-mounting assembly 2 includes a rectangular switch-mounting frame 3 and a panel unit 4.

The switch-mounting frame 3 has a first side 31 adapted to installed with the switch units 6, and a second side 32 opposite to the first side 31 and adapted to face the coupling member 7. The switch-mounting frame 3 is formed with a plurality of first through holes 33 that extend from the first side 31 to the second side 32 and that are adapted to be aligned respectively with the threaded holes 72 in the coupling plates 71 of the coupling member 7.

The panel unit 4 includes a cover 41, a plurality of screw fasteners 43, and a plurality of decorative pieces 42.

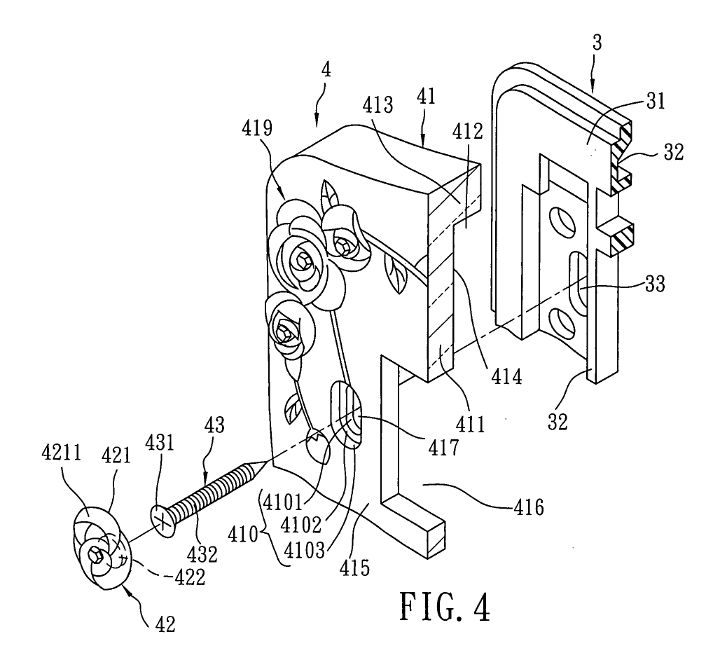

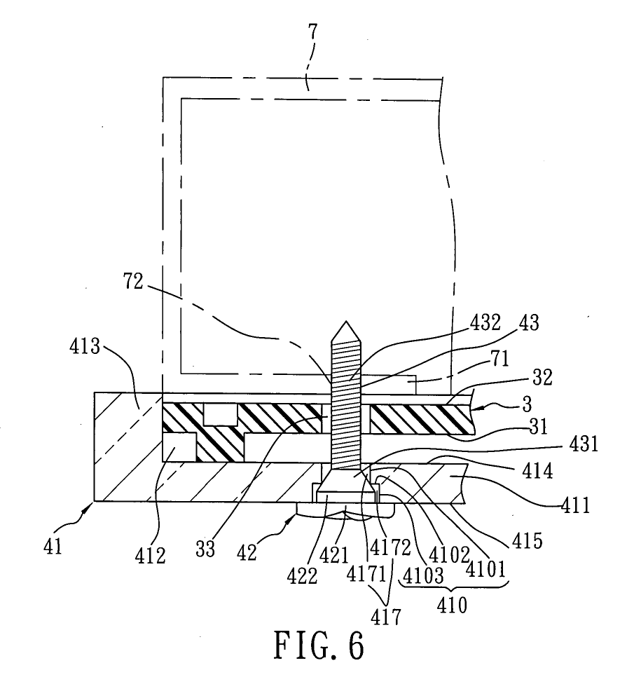

Referring further to FIG. 6, the cover 41 covers the first side 31 of the switch-mounting frame 3. In this embodiment, the cover 41 has a cover wall 411, and a surrounding wall 413 extending from a periphery of the cover wall 411 toward the coupling member 7, disposed around the switch-mounting frame 3, and cooperating with the cover wall 411 to define a receiving space 412 for receiving the switch-mounting frame 3 therein. The cover wall 411 has an inner surface 414 that faces the switch-mounting frame 3, and an outer surface 415 opposite to the inner surface 414, and is formed with a plurality of switch-mounting holes 416 extending from the inner surface 414 to the outer surface 415 and adapted for permitting extension of the switch units 6 on the switch-mounting frame 3 therethrough, respectively, and a plurality of second through holes 417 extending from the inner surface 414 to the outer surface 415 and aligned respectively with the first through holes 33 in the switch-mounting frame 3. In this embodiment, each of the second through holes 417 in the cover wall 411 of the cover 41 has a first hole portion 4171 disposed adjacent to the inner surface 414 of the cover wall 411, and a second hole portion 4172 disposed adjacent to the outer surface 415 of the cover wall 411 and having a diameter larger than that of the first hole portion 4171. Each second through hole 417 in the cover wall 411 of the cover 41 is defined by an annular inner wall 410 that has a first annular wall portion 4101 disposed adjacent to the inner surface 414 of the cover wall 411 of the cover 41 and defining the first hole portion 4171, a second annular wall portion 4103 disposed adjacent to the outer surface 415 of the cover wall 411 and defining the second hole portion 4172, and an annular shoulder portion 4102 interconnecting the first and second annular wall portions 4101, 4103. Furthermore, for decorative purposes, the outer surface 415 of the cover wall 411 of the cover 41 is formed with a plurality of decorative patterns 419 that project from the outer surface 415 of the cover wall 411, as shown in FIG. 4.

Each screw fastener 43 has a magnetically-attractable screw head portion 431, and a screw shank portion 432 connected to the screw head portion 431 and extending through a corresponding one of the second through holes 417 in the cover wall 411 of the cover 41 and a corresponding one of the first through holes 33 in the switch-mounting frame 3 and adapted to be screwed into a corresponding one of the threaded holes 72 in the coupling plates 71 of the coupling member 7 such that an assembly of the switch-mounting frame 3 and the cover 41 is adapted to be anchored to the coupling member 7, as shown in FIG. 6. In this embodiment, for each screw fastener 43, the screw head portion 431 abuts against the annular shoulder portion 4102 of the annular inner wall 410 defining the corresponding one of the second through holes 417, as shown in FIG. 6.

Each decorative piece 42 has a magnetic portion 422 attracting magnetically and contacting the screw head portion 431 of a corresponding one of the screw fasteners 43, and a decorative portion 421 connected to the magnetic portion 422, disposed on the outer surface 415 of the cover wall 411 of the cover 41, and having an area larger than that of the screw head portion 431 of the corresponding one of the screw fasteners 43 so as to cover the screw head portion 431 of the corresponding one of the screw fasteners 43, as shown in FIG. 6. In this embodiment, the decorative portion 421 of each decorative piece 42 is formed with a projecting decorative pattern 4211 compatible with the decorative patterns 419 on the outer surface 415 of the cover wall 411 of the cover 41. As such, the panel unit 4 has an attractive appearance.

It is noted that the assembly of the cover 41 and the screw-mounting frame 3 can be anchored to the coupling member 7 by means of only the screw fasteners 43, thereby facilitating assembly. On the other hand, the screw fasteners 43 can be easily removed after the decorative pieces 42 are manually removed, thereby facilitating disassembly.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A switch-mounting assembly adapted to be mounted with a switch unit and adapted to be connected detachably to a coupling member, said switch-mounting assembly comprising:
a switch-mounting frame having a first side adapted to be installed with the switch unit, and a second side opposite to said first side and adapted to face the coupling member, said switch-mounting frame being formed with a first through hole that extends from said first side to said second side; and
a panel unit including
a cover covering said first side of said switch-mounting frame and having an inner surface that faces said switch-mounting frame, and an outer surface opposite to said inner surface, said cover being formed with a switch-mounting hole extending from said inner surface to said outer surface and adapted for permitting extension of the switch unit on said switch-mounting frame therethrough, and a second through hole extending from said inner surface to said outer surface and aligned with said first through hole in said switch-mounting frame,
a screw fastener having a magnetically-attractable screw head portion, and a screw shank portion connected to said screw head portion and extending through said second through hole in said cover and said first through hole in said switch-mounting frame and adapted to be screwed into the coupling member such that an assembly of said switch-mounting frame and said cover is adapted to be anchored to the coupling member, and
a decorative piece having a magnetic portion attracting magnetically and contacting said screw head portion of said screw fastener, and a decorative portion connected to said magnetic portion, disposed on said outer surface of said cover, and having an area larger than that of said screw head portion of said screw fastener so as to cover said screw head portion of said screw fastener.

2. The switch-mounting assembly as claimed in claim 1, wherein said cover of said panel unit has a cover wall formed with said switch-mounting hole and said second through hole and having said outer surface, and a surrounding wall extending from a periphery of said cover wall toward the coupling member, disposed around said switch-mounting frame, and cooperating with said cover wall to define a receiving space for receiving said switch-mounting frame therein.

3. The switch-mounting assembly as claimed in claim 1, wherein said outer surface of said cover of said panel unit is formed with a plurality of decorative patterns.

4. The switch-mounting assembly as claimed in claim 3, wherein said decorative patterns on said outer surface of said cover of said panel unit project outwardly from said outer surface of said cover.

5. The switch-mounting assembly as claimed in claim 4, wherein said decorative portion of said decorative piece of said panel unit is formed with a projecting decorative pattern compatible with said decorative patterns on said outer surface of said cover of said panel unit.

6. The switch-mounting assembly as claimed in claim 1, wherein said second through hole in said cover is defined by an annular inner wall that has a first annular wall portion disposed adjacent to said inner surface of said cover, a second annular wall portion disposed adjacent to said outer surface of said cover, and an annular shoulder portion interconnecting said first and second annular wall portions, said screw head portion of said screw fastener abutting against said annular shoulder portion of said annular inner wall.

7. A panel unit adapted for use with a switch device connected detachably to a coupling member, the switch device including a switch-mounting frame that has a first side, and a second side opposite to the first side and facing the coupling member and that is formed with a first through hole that extends from the first side to the second side, a switch unit mounted on the first side of the switch-mounting frame, and a screw fastener having a magnetically-attractable screw head portion, and a screw shank portion connected to the screw head portion and extending through the first through hole in the switch-mounting frame and screwed into the coupling member, said panel unit comprising:
a cover adapted to cover the first side of the switch-mounting frame and having an inner surface that is adapted to face the switch-mounting frame, and an outer surface opposite to said inner surface, said cover being formed with a switch-mounting hole extending from said inner surface to said outer surface and adapted for permitting extension of the switch unit on the switch-mounting frame therethrough, and a second through hole extending from said inner surface to said outer surface and adapted to be aligned with the first through hole in the switch-mounting frame and adapted for permitting extension of the screw shank portion of the screw fastener; and
a decorative piece having a magnetic portion adapted to attract magnetically and contact the screw head portion of the screw fastener, and a decorative portion connected to said magnetic portion, disposed on said outer surface of said cover, and having an area larger than that of the screw head portion of the screw fastener so as to cover the screw head portion of the screw fastener.

8. The panel unit as claimed in claim 7, wherein said cover has a cover wall formed with said switch-mounting hole and said second through hole and having said outer surface, and a surrounding wall extending from a periphery of said cover wall toward the coupling member, adapted to be disposed around the switch-mounting frame, and cooperating with said cover wall to define a receiving space adapted for receiving the switch-mounting frame therein.

9. The panel unit as claimed in claim 7, wherein said outer surface of said cover is formed with a plurality of decorative patterns.

10. The panel unit as claimed in claim 9, wherein said decorative patterns on said outer surface of said cover project outwardly from said outer surface of said cover.

11. The panel unit as claimed in claim 10, wherein said decorative portion of said decorative piece is formed with a projecting decorative pattern compatible with said decorative patterns on said outer surface of said cover.

12. The panel unit as claimed in claim 7, wherein said second through hole in said cover is defined by an annular inner wall that has a first annular wall portion disposed adjacent to said inner surface of said cover, a second annular wall portion disposed adjacent to said outer surface of said cover, and an annular shoulder portion interconnecting said first and second annular wall portions, the screw head portion of said screw fastener abutting against said annular shoulder portion of said annular inner wall.
